(19) United States
(12) Patent Application Publication
(10) Pub. No.: US 2010/0124702 A1
(43) Pub. Date: May 20, 2010

(54) High Energy Composite Cathodes for Lithium Ion Batteries

(75) Inventor: Kevin C. White, Hudson, MA (US)

Correspondence Address: PROSKAUER ROSE LLP, ONE INTERNATIONAL PLACE, BOSTON, MA, 02110, US

(73) Assignee: Physical Sciences, Inc., Andover, MA (US)

(21) Appl. No.: 12/272,157

(22) Filed: Nov. 17, 2008

(51) Int. Cl. H01M 4/62; H01B 1/24; H01B 1/12; H01M 4/02; B05D 5/12

(52) U.S. Cl. 429/217; 252/506; 252/519.33; 427/77; 429/209

(57) ABSTRACT

A battery cathode includes carbon particulates, micron-sized particles of vanadium pentoxide modified with poly(pyrrole propanesulphonate), and a polymer binder. The carbon particulates and the micron-sized particles of vanadium pentoxide modified with poly(pyrrole propanesulphonate) are disposed within the polymer binder.

### GOVERNMENT RIGHTS

This invention was made with government support under Contract No. F33615-03-C-2369 awarded by the United States Air Force. The government may have certain rights in the invention.

### FIELD OF THE INVENTION

In general, the invention relates to materials for use as battery cathodes. In particular, the invention relates to composite materials and methods of making and using the composite materials in batteries.

### BACKGROUND OF THE INVENTION

Lithium ion batteries are a type of rechargeable battery commonly used in consumer electronics. They are currently one of the most popular types of battery, with one of the best energy-to-weight ratios, minimal memory effect and a slow loss of charge when not in use. Lithium ion batteries are significantly lighter than equivalents in other chemistries such as, for example, lead-acid, nickel-metal hydride, and nickel cadmium.

However, lithium ion batteries show limited applications in certain space and terrestrial applications due to the limited performance at the cathode. This limited performance is due to the limited specific energies and capacities of the cathode material. A variety of metals, metal oxides and metal complexes can be used as cathode materials for lithium ion batteries. Vanadium pentoxide (V₂O₅), in particular, exhibits a high theoretical capacity of 600 Ah/kg and theoretical energy of 1600 Wh/kg because of its ability to intercalate four electrons per formula unit. However, it has not yet been implemented in commercial rechargeable batteries because its available capacity is limited to two electrons per formula unit and its reversible capacity to one electron per formula unit. Without wishing to be bound by theory, concentration polarization driven by poor electronic conductivity and irreversible phase changes upon intercalation past LiV₂O₅ may be the reasons for this drawback.

### SUMMARY OF THE INVENTION

The invention features a composite material including a plurality of particulates for use in battery cathodes. The invention also features methods of making and using the composite material.

In one aspect, the invention features a battery cathode including carbon particulates, micron-sized particles of vanadium pentoxide modified with poly(pyrrole propanesulphonate) (PPPS), and a polymer binder. The carbon particulates and the micron-sized particles of vanadium pentoxide modified with poly(pyrrole propanesulphonate) are disposed within the polymer binder.

In another aspect, the invention features a battery cathode including carbon particulates, micron-sized particles of vanadium pentoxide, a conducting polymer and a polymer binder. The micron-sized particles of vanadium pentoxide are modified with the conducting polymer to form a bi-layer ribbon structure having a bi-layer spacing of about 13.5 to about 15 Angstroms. The carbon particulates and the micron-sized particles of vanadium pentoxide modified with the conducting polymer are disposed within the polymer binder.

In yet another aspect, the invention features a method of making a cathode composite by forming a xerogel of poly(pyrrole propanesulphonate) modified vanadium pentoxide. The xerogel is processed to form micron-sized particles of poly(pyrrole propanesulphonate) modified vanadium pentoxide. The micron-sized particles of poly(pyrrole propanesulphonate) modified vanadium pentoxide are mixed with carbon particulates and a polymer binder to form the cathode composite.

In another aspect, the invention features a method of making a battery cathode. An adhesion layer is applied to an aluminum foil current collector. A slurry is deposited on the adhesion layer. The slurry includes particulates of carbon, micron-sized particles of vanadium pentoxide modified with poly(pyrrole propanesulphonate), and a polymer binder. The deposited slurry is dried to form the battery cathode.

In yet another aspect, the invention features a battery including a cathode, an anode, a porous separator, and an electrolytic solution. The cathode includes a layer of composite material formed from (i) particulates of carbon, (ii) micron-sized particles of vanadium pentoxide modified with poly(pyrrole propanesulphonate), and (iii) a polymer binder. The anode includes lithium ions. The porous separator and the electrolytic solution are disposed between the cathode and the anode.

In another aspect, the invention features a method of making composite particulates. A xerogel of poly(pyrrole propanesulphonate) modified vanadium pentoxide, is formed. The xerogel is milled to form micron-sized particulates of poly(pyrrole propanesulphonate) modified vanadium pentoxide.

In other examples, any of the aspects above can include one or more of the following features. The micron-sized particles of vanadium pentoxide modified with poly(pyrrole propanesulphonate) can include at most 400 ppm of poly(pyrrole propanesulphonate). In certain embodiments, the micron-sized particles of vanadium pentoxide modified with poly(pyrrole propanesulphonate) can include between 150 ppm and 300 ppm poly(pyrrole propanesulphonate). In certain embodiments, the micron-sized particles of vanadium pentoxide modified with poly(pyrrole propanesulphonate) can make up about 75 weight percent to 90 weight percent of the total weight.

The carbon particulates can make up about 7 weight percent to 15 weight percent of the total weight. In certain embodiments, the polymer binder can make up about 3 weight percent to 10 weight percent of the total weight.

In some embodiments, the carbon particulates can be acetylene black particles, graphite flakes, or combinations thereof. The polymer binder can be polyvinylidene fluoride. In certain embodiments, the composite material can be included in a slurry.

In some embodiments, the xerogel of poly(pyrrole propanesulphonate) modified vanadium pentoxide can be formed by mixing vanadium(V)oxytrialkoxides and water to form vanadium pentoxide hydrogel having a bi-layer ribbon structure with a bi-layer spacing of about 9 Angstroms to about 13 Angstroms. Poly(pyrrole propanesulphonate) in monomer form can be added to the water used to form the vanadium pentoxide hydrogel. Triisopropoxy vanadium oxide can be introduced dropwise into the water solution, and excess water can be removed.

In certain embodiments, the xerogel can include at most 400 ppm of poly(pyrrole propanesulphonate). In some embodiments, the xerogel can be processed by milling. An attritor mill can be used to produce particles having an average size of about 5 to about 10 microns.

In certain embodiments, the adhesion layer can include a mixture of graphite flakes and a hydrophilic binder. The adhesion layer can have a thickness of about 10 microns to about 12 microns. In some embodiments, the slurry can be deposited using draw casting. The slurry can be dried to form a layer having a thickness of about 5 microns to about 500 microns.

In some embodiments, the micron-sized particles of vanadium pentoxide modified with poly(pyrrole propanesulphonate) can have an average size of about 5 to 10 microns. The micron-sized particles of vanadium pentoxide modified with poly(pyrrole propanesulphonate) can include about 400 ppm of poly(pyrrole propanesulphonate). The micron-sized particles of vanadium pentoxide modified with poly(pyrrole propanesulphonate) can include between about 75 weight percent and about 90 weight percent of the composite material. The carbon particulates can include between about 7 weight percent and about 15 weight percent of the composite material. The polymer binder can include between about 3 weight percent and 10 weight percent of the composite material.

The xerogel of poly(pyrrole propanesulphonate) modified vanadium pentoxide can be formed by mixing vanadium(V)oxytrialkoxides and water to the water used to form the vanadium pentoxide hydrogel. Poly(pyrrole propanesulphonate) in monomer form can be added to the hydrogel to form a solution. Triisopropoxy vanadium oxide can be introduced dropwise into the water solution. Excess water can be removed to form the xerogel. The vanadium pentoxide hydrogel can have a bi-layer ribbon structure with a bi-layer spacing of about 9 Angstroms to about 13 Angstroms. An attritor mill can be used to produce particulates of the xerogel. The particulates can have an average size of about 5 to about 10 microns.

A composite V₂O₅ cathode material can improve rechargeable lithium ion battery performance. A V₂O₅/PPPS material can be inherently more resistive than a typical rechargeable cell based on LiCoO₂. A high performance cathode can enhance the applicability of lithium ion batteries in certain space and terrestrial applications.

The details of one or more examples are set forth in the accompanying drawings and description. Further features, aspects, and advantages of the invention will become apparent from the description, the drawings, and the claims.

### BRIEF DESCRIPTION OF DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary high energy lithium ion battery

FIG. 2 shows an exemplary battery cathode.

FIG. 3 shows an example of the V₂O₅/conducting polymer interaction.

FIG. 4 shows the relative resistance of V₂O₅ as a function of oxidation state.

FIG. 5 shows the ¹H NMR of PPPS monomer, 3-(pyrrol-1-yl)-propanesulphonate.

FIG. 6 shows the ¹³C NMR of PPPS monomer, 3-(pyrrol-1-yl)-propanesulphonate.

FIG. 7 shows the ¹H-NMR spectrum of EDOPPS.

FIG. 8 shows the mass spectrum of EDOPPS.

FIG. 9 shows the FESEM image of the milled composite cathode material.

FIG. 10 shows the FESEM Image of a prepared cathode at 500 and 5000× magnification.

FIG. 11 shows the XRD data for V₂O₅/PPPS composites.

FIG. 12 shows the XRD data for 3 loadings of PEDOPPS in V₂O₅. The inset shows angles from 2° to 6° 2Θ.

FIGS. 13a-13c show the electron diffraction patterns and indexing data for the V₂O₅ samples.

FIG. 14 shows the particle size distribution for the milled composite cathode material—d₁₀=0.47 μm, d₅₀=1.6 μm, d₉₀=8 μm.

FIG. 15 shows the discharge curves at the 3rd cycle for three cells including V₂O₅ composite cathode and lithium metal anode at three discharge rates.

FIG. 16 shows the discharge performance of two cells at the C/8 rate—V₂O₅ vs. lithium.

FIG. 17 shows the discharge interrupt testing showing the difference in polarization between a commercial 18650 lithium-ion and a V₂O₅/PPPS battery.

### DETAILED DESCRIPTION OF THE INVENTION

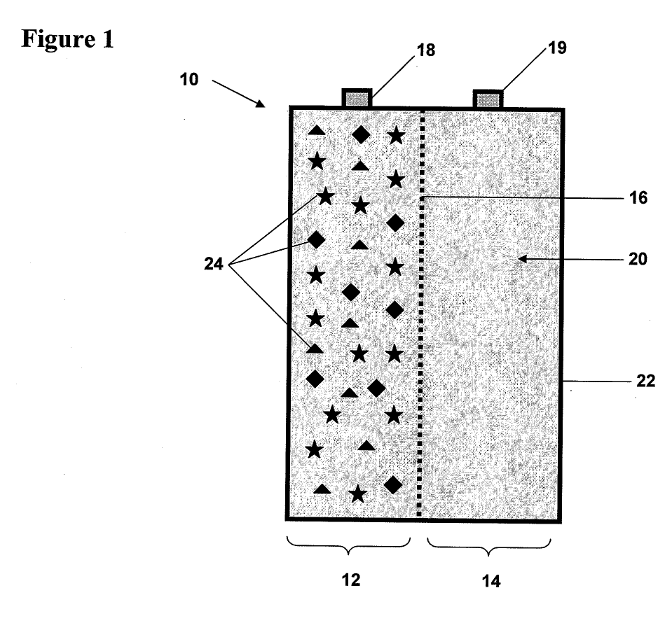

FIG. 1 shows a battery 10 including a cathode 12 separated from an anode 14 by a porous separator 16. In one embodiment, the battery 10 is a high energy lithium ion battery. The anode 14 can be a lithium ion anode. The cathode 12 includes a terminal 18, and the anode 14 includes a terminal 19. The battery 10 includes an electrolytic solution 20 capable of passing through the porous separator 16. The battery 10 include a casing 22. The cathode 12 can include a composite material 24.

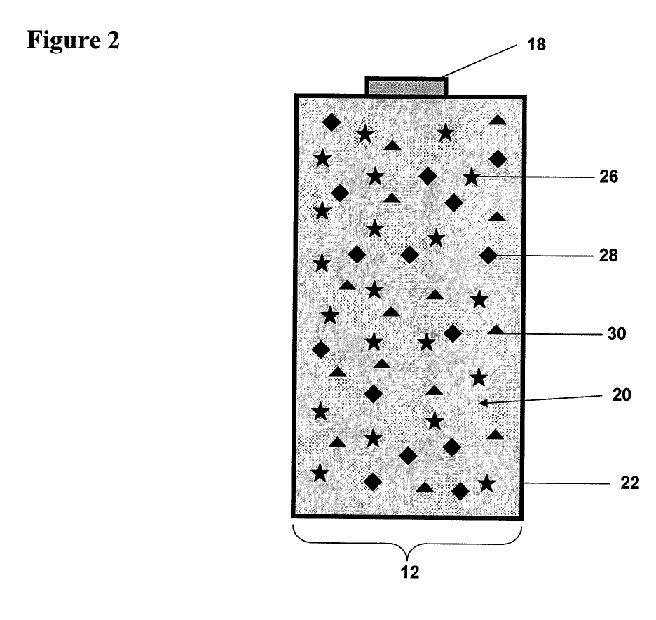

FIG. 2 shows an enlarged view of the composite material 24 including micron-sized particles 26 of vanadium pentoxide modified with a conducting polymer, carbon particulates 28, and a polymer binder 30. The cathode 12 can be prepared by coating an aluminum foil current collector with an adhesion layer. A slurry of composite material 24 can be deposited over the adhesion layer. In general, the slurry can be a mixture of the composite material 24 and a suitable solvent, for example, N-methylpyrrolidone (NMP) an electronic conductor such as acetylene black and a polymeric binder.

The composite material 24 can be prepared by forming a gel of vanadium pentoxide modified with a conducting polymer. A monomer of a conducting material such as pyrrole propanesulphonate (PPS) can be mixed with a vanadium trialkoxide and water. The resulting hydrolysis and polymerization reactions can lead to the formation of a gel in which the vanadium oxide self-assembles into a bi-layer ribbon-like structure and the PPS polymerizes to the corresponding conducting polymer poly(pyrrole propanesulphonate) (PPPS).

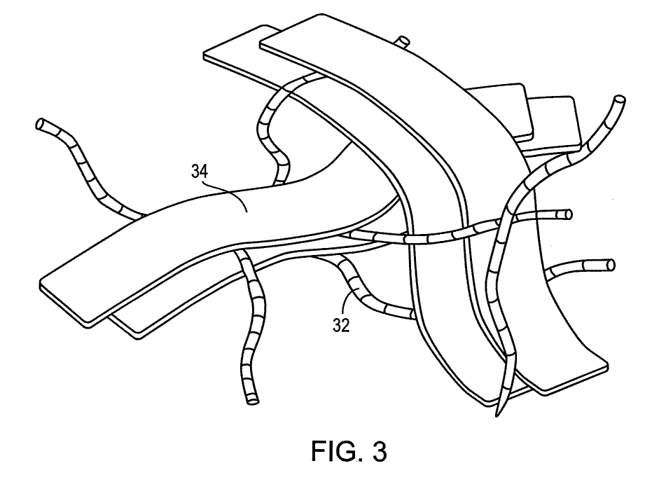

As shown in FIG. 3, conducting polymer chains 32 can grow between bi-layers 34 to form an interpenetrating polymer network having intimate contact with the bi-layers 34. In some embodiments, the gel can have a significant amount of water (e.g., as much as 99% by weight) entrapped in the bi-layers and is called a hydrogel. In certain embodiments, the gel does not have a significant amount of water and is called a xerogel. The hydrogel can be further dried to form the corresponding xerogel. The xerogel can be milled to form micron-sized particles which can be mixed with carbon particulates and/or polymer binders.

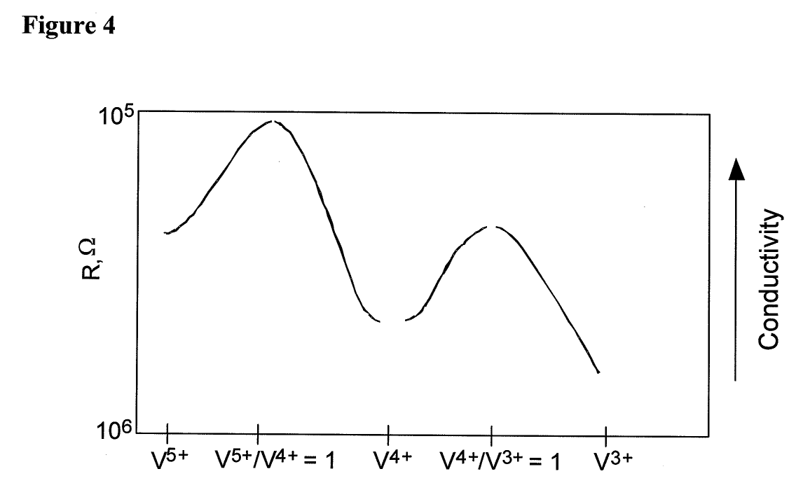

Vanadium pentoxide (V₂O₅) has a high theoretical capacity of 600 Ah/kg and theoretical energy of 1600 Wh/kg. This is because of its unique ability to intercalate four electrons per formula unit. In general, it is a poor conductor in which the thermally activated electron transport occurs through the hopping of vanadium's d electrons between V⁴⁺ and V⁵⁺ centers and between V³⁺ and V⁴⁺ centers on further reduction. FIG. 4 represents this concept graphically.

A variety of carbon particulates can be used in the composite material 24. For example, elemental carbon black, acetylene black, or graphite flakes can be used. A variety of polymer binders are commercially available and can be used in the composite material 24. For example, polyvinylidene fluoride (PVF) can be used.

The anode 14 can be prepared by using commercially available graphite anode material for example, material available from Lithion Inc., Connecticut. The anode 14 can be electrochemically lithiated. In certain embodiments, a graphite based material can be coated, covered or electroplated with lithium metal.

The porous separator 16 can be prepared using commercially available material, for example, Celgard® 2400 available from Celgard LLC, North Carolina. In certain embodiments, a polymer membrane such as, for example, polyethylene membrane can be used.

The electrolytic solution 20 can be prepared using commercially available material, for example, an electrolytic solution available from Sigma-Aldrich, Missouri. In some embodiments, solid lithium salts such as, for example, LiPF₆, LiBF₄, or LiClO₄ can be used. In certain embodiments, commercially available organic liquids such as for example ether can be used. In various embodiments, solid materials such as organic carbonates, for example, ethylene carbonate, and dimethyl carbonate can be used. In some embodiments, mixtures of solids and liquids in different proportions can be used.

The outer shell casing 22 of the battery 10, can be prepared using commercially available material. In some embodiments, the casing can be a polymer. In certain embodiments, the casing can be made of metal alloys, such as for example, stainless steel.

### Preparation of Conducting Polymers

The synthesis of included polymers can be characterized by the preparation of the corresponding monomers. The syntheses described below are for illustration and should not be construed as limiting the scope of the invention.

Pyrrole Propanesulphonate (PPS) Synthesis

Scheme 1 depicts a synthesis of PPS. Freshly distilled pyrrole (1.3 mL) in DMSO (18 mL) at 60° C. can be added to a suspension of NaH (60% in mineral oil) (0.8 g) in dry DMSO (10 mL) under constant stirring and an argon atmosphere over ˜1 hour. 1,3-propane sultone (2.45 g) can be melted with a heat gun and added dropwise to the reaction mixture. Following the addition, the solution can be allowed to stir at 60° C. for an additional 2 hours. The reaction mixture can be then poured into acetone (300 mL), and CHCl₃ can be added causing a white solid to precipitate. The solid can be filtered, washed with hot THF (3×100 mL), washed with hexanes (100 mL), and dried under vacuum at room temperature to give 2.7 g (64% yield) of an off-white solid.

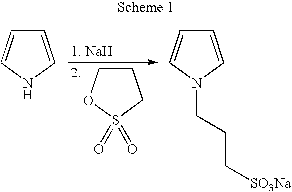

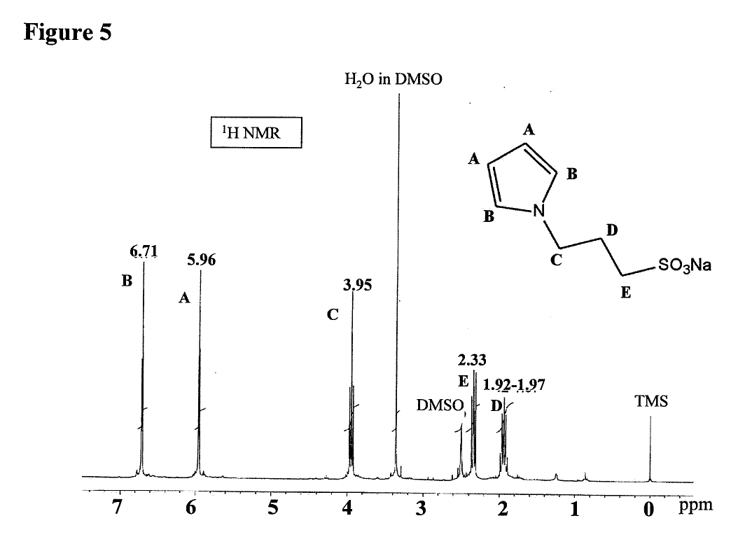

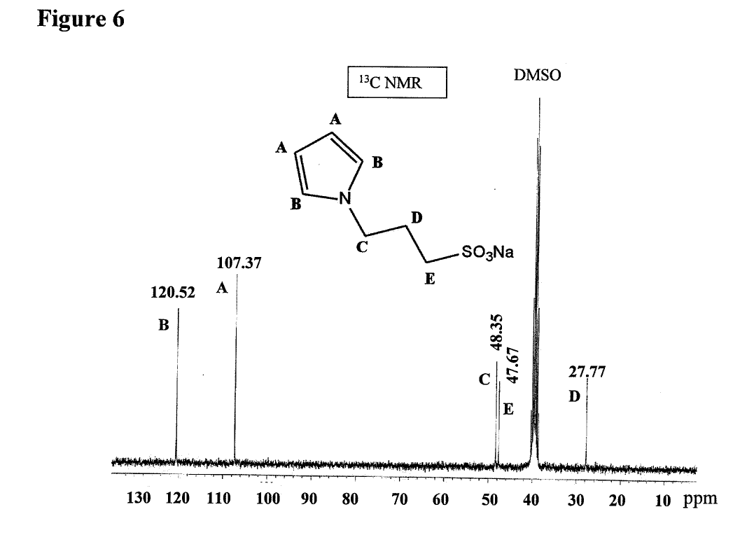

FIG. 5 shows a proton NMR of PPS. ¹H NMR (DMSO-d₆, 300 MHz): δ 1.92-1.97 (2H, m), 2.33 (2H, t, J=7 Hz), 3.95 (2H, t, J=7 Hz), 5.96 (2H, t, J=2 Hz), 6.71 (2H, t, J=2 Hz). FIG. 6 shows a carbon NMR of PPS. ¹³C NMR (DMSO-d₆, 75 MHz): δ 27.77, 47.67, 48.35, 107.37, 120.52.

Ethylenedioxypyrrole Propanesulphonate (EDOPPS) Synthesis

Sodium 3-(3,4-Ethylenedioxypyrrol-1-yl)propanesulfonate (EDOPPS) can be prepared using nine synthetic steps.

### Bis-methoxycarbonylmethyl-ammonium; chloride 1

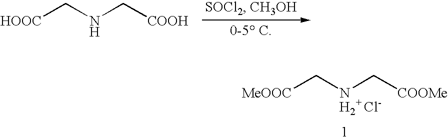

### (Methoxycarbonylmethyl-amino)-acetic acid methyl ester 2

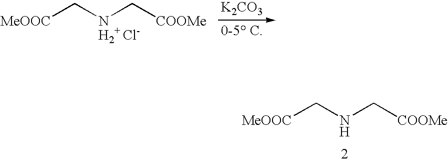

### (Benzyl-methoxycarbonylmethyl-amino)-acetic acid methyl ester 3

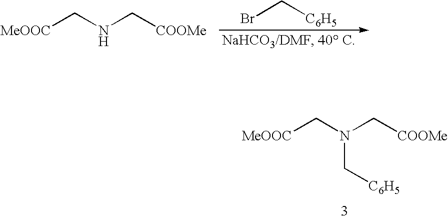

### 1-Benzyl-3,4-dihydroxy-1H-pyrrole-2,5-dicarboxylic acid dimethyl ester 4

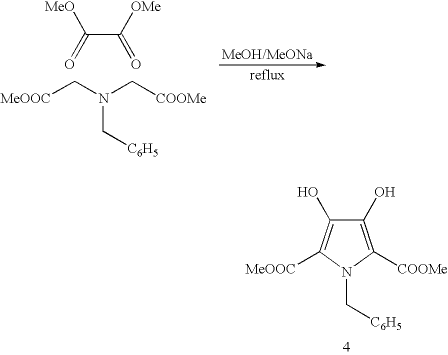

### 6-Benzyl-2,3-dihydro-6H-[1,4]dioxino[2,3-c]pyrrole-5,7-dicarboxylic acid dimethyl ester 5

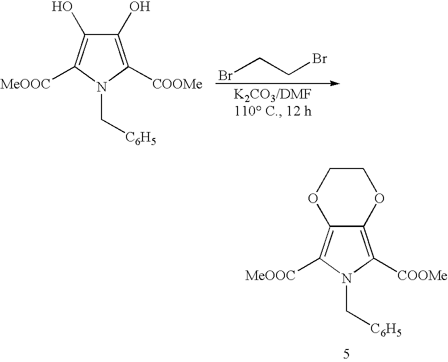

### 2,3-Dihydro-6H-[1,4]dioxino[2,3-c]pyrrole-5,7-dicarboxylic acid dimethyl ester 6

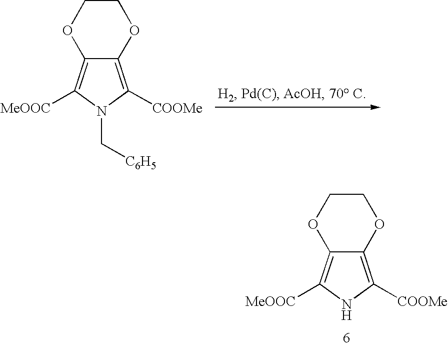

### 2,3-Dihydro-6H-[1,4]dioxino[2,3-c]pyrrole-5,7-dicarboxylic acid 7

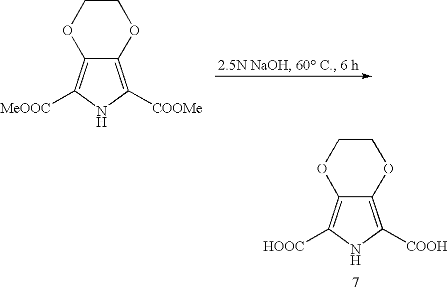

### 2,3-Dihydro-6H-[1,4]dioxino[2,3-c]pyrrole 8 (EDOP)

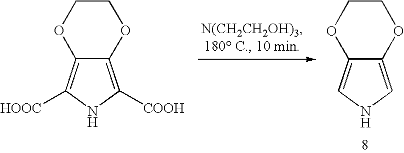

### Sodium 3-(3,4-Ethylenedioxypyrrol-1-yl)propanesulfonate 9

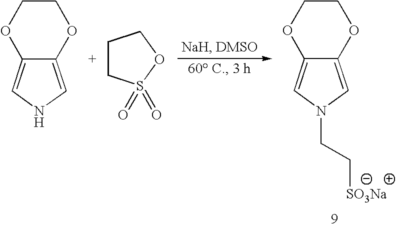

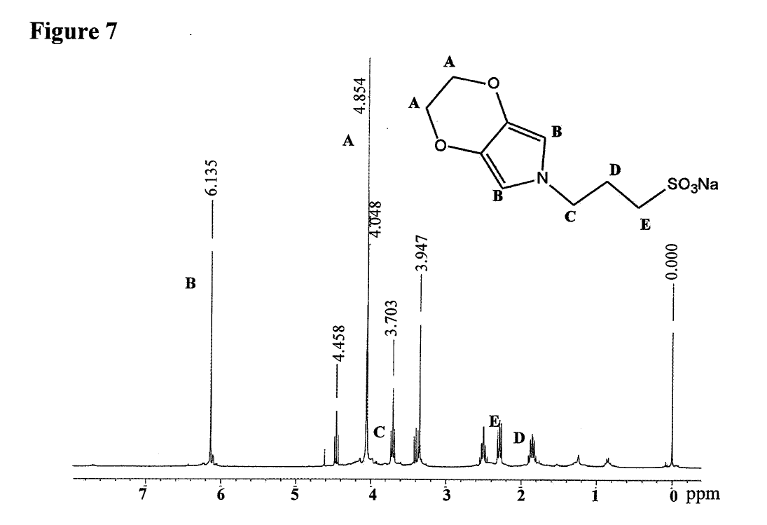

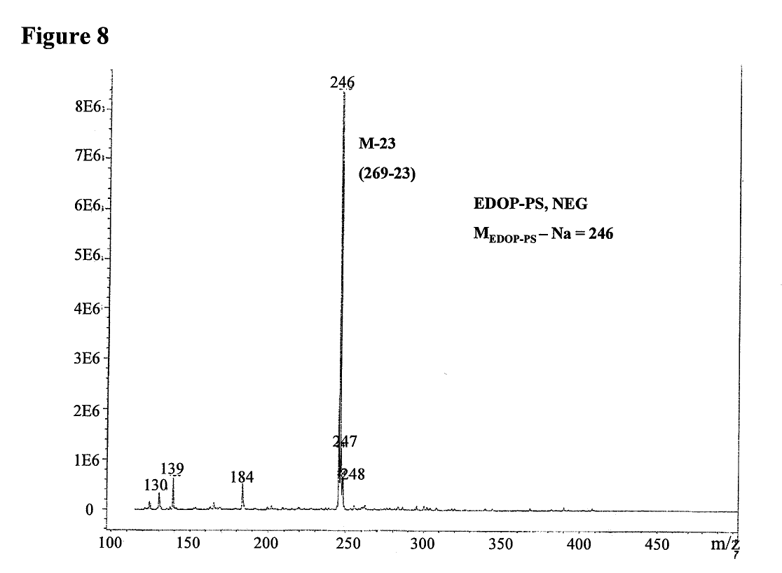

The N-alkylation of EDOP with a pendant (propanesulfonate) can be achieved by reacting EDOP with propanesultone and NaH in THF at 0° C. By adapting the procedure used for the preparation of ProDOT-PS, it is possible to isolate EDOPPS 9 in 50% yield (98% purity by LC-MS). FIGS. 7 and 8 highlight the NMR data and mass spectrum of compound 9 respectively.

Monomers of other conducting polymers known in the art such as poly(acetylene)s, poly(pyrrole)s, poly(thiophene)s, poly(aniline)s, poly(fluorene)s, poly(3-hexylthiophene), polynaphthalenes, poly(p-phenylene sulfide), and poly(para-phenylene vinylene)s can be prepared and characterized using the above synthetic protocol for the purposes of this invention.

### Preparation of Hydrogel and Xerogel

A sol-gel method can be used to prepare a hydrogel and xerogel of the cathode material. Vanadium oxytrialkoxides can be mixed with water and made to undergo a hydrolysis reaction. Typically, a round bottom flask can be charged with water. To avoid pre-polymerization of introduced conducting polymer monomers, dissolved oxygen can be purged from the water in the flask by bubbling argon. The monomer for the desired conducting polymer can be introduced as a solution by syringe through a rubber septum. Usually, about 50-200 g of a vanadium trialkoxide such as triisopropoxy vanadium oxide (TIVO) per liter of water can be added dropwise by syringe through the rubber septum over the course of 15 minutes to 3 hours. The solution can be vigorously stirred. The resulting solution can be allowed to rest for 12-48 hours in which time gelation of V₂O₅ occurs. Excess water can be removed by rotary evaporation to form a viscous gel. This resulting gel, known as hydrogel, can be allowed to further dry on the bench top for about 12-48 hours. Additional drying at about 50-250° C. can be done to form the corresponding dehydrated gel known as xerogel.

In some embodiments, the hydrogel can have a bi-layer ribbon structure with a bi-layer spacing of about 2 Angstroms to about 60 Angstroms. In certain embodiments, the hydrogel can have a bi-layer ribbon structure with a bi-layer spacing of about 5 Angstroms to about 30 Angstroms. In various embodiments, the hydrogel can have a bi-layer ribbon structure with a bi-layer spacing of about 9 Angstroms to about 13 Angstroms.

The xerogel can include significantly less water than the hydrogel. For example, the water content can be less than about 3.0 parts H₂O per part V₂O₅ Gels can be dried under ambient temperature conditions such as at room temperature and at atmospheric pressure. The temperature and pressure can be varied to get the desired amount of water in the interlayer space and thus a desired thickness of the bi-layers. In one embodiment, a xerogel can have a d-spacing of about 10 to 15 Å. In one embodiment, the d-spacing is about 11.5 to 13 Å. X-ray diffraction can be used to measure the d-spacing. In general, the xerogel can be described by the formula V₂O₅.xH₂O, where x can have a value of about 0.8 to 3. More rigorous drying of the xerogel under mild vacuum at about 10 to 10⁻⁴ torr (e.g., 10⁻² torr) and a temperature of about 150 to 350° C. (e.g., 250° C.) can yield a spacing of about 8.4 to 8.95 Å (e.g., 8.75 Å) and the formula V₂O₅.0.3H₂O.

In some embodiments, the micron-sized particles of vanadium pentoxide modified with poly(pyrrole propanesulphonate) can include 50-1000 ppm of poly(pyrrole propanesulphonate). In certain embodiments, the micron-sized particles of vanadium pentoxide modified with poly(pyrrole propanesulphonate) can include 100-800 ppm of poly(pyrrole propanesulphonate). In various embodiments, the micron-sized particles of vanadium pentoxide modified with poly(pyrrole propanesulphonate) can include 150-300 ppm of poly(pyrrole propanesulphonate). In some embodiments, the micron-sized particles of vanadium pentoxide modified with poly(pyrrole propanesulphonate) can include at most 400 ppm of poly(pyrrole propanesulphonate).

In certain embodiments, the polymer can be in its conducting state from 4 to 1.5 V vs. Li/Li⁺. This is the range in which V₂O₅ is active. Polymers such as, poly(ethylene dioxythiophene) (PEDOT) and poly(N-propane sulfonic acid aniline) (PSPAN), can both conduct below 3.0V vs. Li/Li⁺ and can increase performance during the first two reductions of V₂O₅ (to the uniform V⁴⁺ state). Poly(aniline) can be conductive down to 3.25 V vs. Li/Li⁺. Derivatives of PEDOP and PPPS can be used.

In some embodiments, the micron-sized particles of vanadium pentoxide modified with a conducting polymer such as poly(pyrrole propanesulphonate) can form a bi-layer ribbon structure having a bi-layer spacing of about 3 to about 50 Angstroms. In certain embodiments, the micron-sized particles of vanadium pentoxide modified with a conducting polymer such as poly(pyrrole propanesulphonate) can form a bi-layer ribbon structure having a bi-layer spacing of about 8 to about 30 Angstroms. In various embodiments, the micron-sized particles of vanadium pentoxide modified with a conducting polymer such as poly(pyrrole propanesulphonate) can form a bi-layer ribbon structure having a bi-layer spacing of about 13.5 to about 15 Angstroms.

### Preparation and Characterization of Composite Material

V₂O₅/conducting polymer composite materials can be synthesized by using a sol-gel chemical method. A combination of vanadium(V)oxytrialkoxides and water can result in the hydrolysis of the alkoxy ligands and condensation of the vanadium(V)oxytrihydroxo species to V₂O₅ moieties referred to as hydrogels. V₂O₅ hydrogels can include ribbon like bi-layers of V₂O₅ that can be 100 nm wide, and/or 1000 nm long. The bi-layers can be separated by inter-layer distance of 5 to 11 nanometers. This synthetic approach can provide the ability to cause species to be included between the two halves of the V₂O₅ bi-layer thereby promoting molecular level mixing in a nano-structured material.

When the included species is a monomer that can be oxidatively polymerized, V₂O₅ can act as an electron acceptor and can cause oxidative polymerization of the material. Conducting polymer chains can grow between the V₂O₅ bi-layers to form an interpenetrating polymer network having intimate contact with the V₂O₅ active material. The composites such as PPPS/V₂O₅ and PEDOPPS/V₂O₅ can be characterized by X-ray diffraction, conductivity measurement and/or electron diffraction techniques. The X-ray diffraction studies can be used to detect and measure any structural changes that can occur upon formation of the composite material. Finally, electron diffraction techniques can be used to detect and measure any molecular level changes brought on by polymer inclusion in the V₂O₅ matrix. Additional characterization by infrared spectroscopy or UV-visible spectroscopy can be employed when necessary.

### Preparation of the Battery Cathode

The composite material can be milled to form micron sized particulates. A slurry including the particulates can be formed. An aluminum foil can be treated with an adhesion layer and the slurry.

### (i) V₂O₅ Composite Particulate Formation

The xerogel including the V₂O₅/conducting polymer composite materials can be milled to micron sized particulates using an attritor mill. Attritor milling is a ball milling technique in which the grinding media can be stirred through the target material rather than the shaking action of typical ball mills. An attritor mill can have a central rotating shaft, equipped with several horizontal arms that exert sufficient stirring action to force the grinding media to tumble randomly throughout the whole tank volume, causing irregular movement instead of group movement. The result can be a grinding process that imparts shear and impact forces to the target material (rather than shear forces alone as in ball milling). This action can promote the formation of spherical particulates. The technique can be suited for producing particulate in the sub 10 micron size range.

In some embodiments, milling is used to produce particles having an average size of about 1 to about 100 microns. In certain embodiments, milling is used to produce particles having an average size of about 3 to about 30 microns. In various embodiments, milling is used to produce particles having an average size of about 5 to about 10 microns.

As used herein, micro-sized particles or micron-sized particulates can be defined as the majority of the particles having a dimension between about 0.1 microns and about 100 microns. Thus, while a majority (e.g., about 85 weight percent) of the particles have a dimension between about 0.1 microns and about 100 microns, some of the particles can be outside of this range. For example, while most of the particles as determined by weight percent will have a dimension between about 0.1 microns and about 100 microns, a small portion (e.g., less than about 10 weight percent of the particles) can be smaller than micron-sized and a small portion (e.g., less than 10 weight percent of the particles) can be larger than micron-sized.

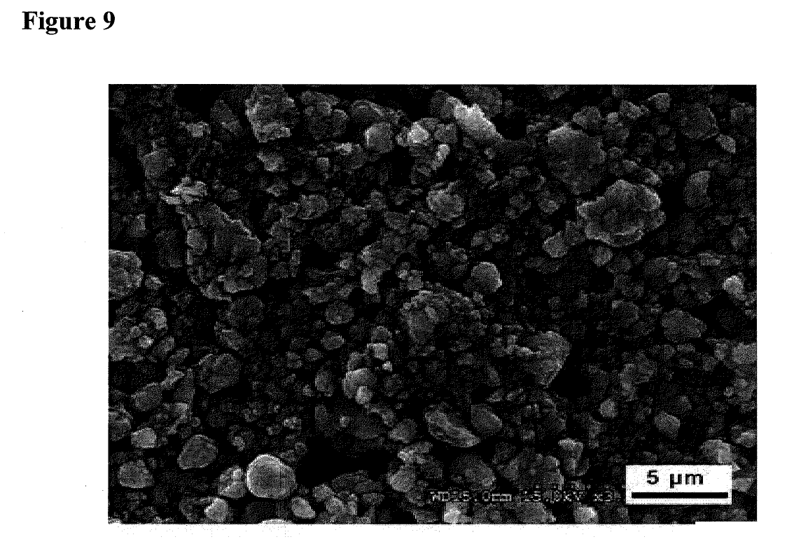

FIG. 9 shows FESEM images of a milled cathode material. The particle size distribution can be comparable to mortar and pestle ground material with the largest particles being less than 10 μm and a median particle size of approximately 5 μm.

### (ii) Slurry Formation

Slurry formation can be the next step in the preparation of the battery cathode. Carbon particulates such as elemental carbon black, acetylene black or graphite flakes can be mixed with the micron sized particulates of the xerogel. In some embodiments, a combination of the above mentioned carbon particulates can be used. A polymer binder such as polyvinylidene fluoride (PVDF) can be added along with a solvent such as N-methyl-2-pyrrolidone (NMP). A homogeneous slurry of the ingredients can be obtained by mixing processes such as high speed shear mixing or ultrasonic mixing or both. The slurry can be optionally subjected to a vacuum to remove any bubbles formed during the mixing step.

In some embodiments, drying the slurry can form a layer having a thickness of about 1 microns to about 1500 microns. In certain embodiments, drying the slurry can form a layer having a thickness of about 3 microns to about 1000 microns. In various embodiments, drying the slurry can form a layer having a thickness of about 5 microns to about 500 microns.

(iii) Electrode Preparation

Standard methods to prepare cathodes of lithium ion batteries can be used for the composite electrode preparation. A commercially available aluminum foil current collector can be treated with an adhesion layer. A cathode slurry can be applied. Drying and optional calendaring of the slurry can result in the desired cathode.

### (iv) Adhesion Layer

The adhesion layer can include a hydrophilic binder, water and high conductivity graphite flakes. The desired thickness or consistency of the adhesion layer can be controlled by the amounts of water and solids. The adhesion layer can be applied to the aluminum foil current collector. An automatic drawdown doctor blade apparatus can be used to apply the adhesion layer. The layer can be dried under heat and/or reduced pressure.

In some embodiments, the adhesion layer has about a 3 microns to about 50 microns thickness. In certain embodiments, the adhesion layer has about a 6 microns to about 20 microns thickness. In various embodiments, the adhesion layer has about a 10 microns to about 12 microns thickness.

### (v) Slurry Deposition

The slurry can be deposited by draw casting, which involves an automatic drawdown doctor blade machine. Such a device can ensure repeatable constant velocity of the doctor blade.

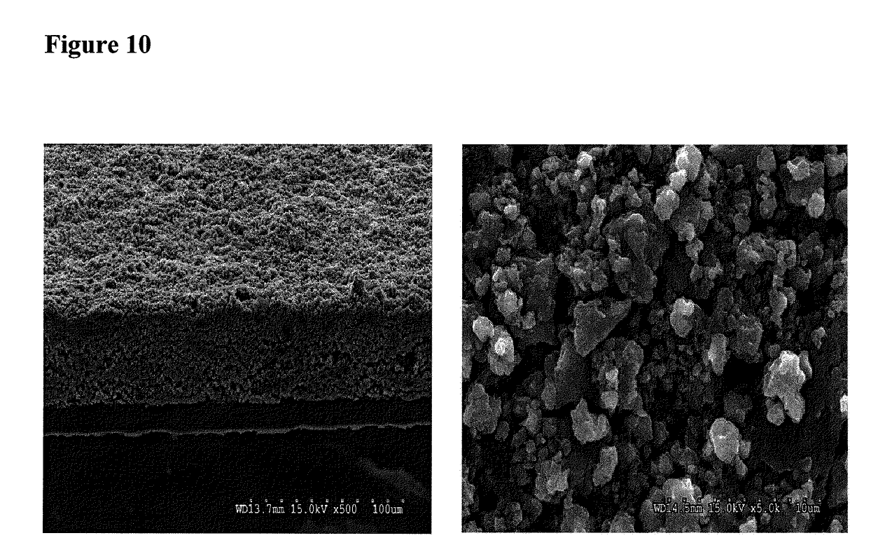

An aluminum foil can be fixed on the stage of the auto-drawdown machine and cleaned with methanol. The doctor blade assembly can be placed on the right side of the drawdown machine and excess cathode slurry can be placed in front of the doctor blade assembly. Electrodes can be cast at a drawdown velocity of 2 inches per second. The electrodes can be dried at 100° C. for 1 hour and then for 24 hours at 110° C. under vacuum to remove residual solvent. An SEM image of a typical draw cast electrode is shown in FIG. 10.

In some embodiments, the battery cathode can include micron-sized particles of vanadium pentoxide modified with poly(pyrrole propanesulphonate) between about 50 weight percent and about 99 weight percent of the total weight. In certain embodiments, the battery cathode can include micron-sized particles of vanadium pentoxide modified with poly(pyrrole propanesulphonate) between about 60 weight percent and about 94 weight percent of the total weight. In various embodiments, the battery cathode can include micron-sized particles of vanadium pentoxide modified with poly(pyrrole propanesulphonate) between about 75 weight percent and about 90 weight percent of the total weight.

In some embodiments, the battery cathode can include carbon particulates between about 1 weight percent and about 45 weight percent of the total weight. In certain embodiments, the battery cathode can include carbon particulates between about 3 weight percent and about 30 weight percent of the total weight. In various embodiments, the battery cathode can include carbon particulates between about 7 weight percent and about 15 weight percent of the total weight.

In some embodiments, the battery cathode can include polymer binder between about 1 weight percent and about 30 weight percent of the total weight. In certain embodiments, the battery cathode can include polymer binder between about 2 weight percent and about 20 weight percent of the total weight. In various embodiments, the battery cathode can include polymer binder between about 3 weight percent and about 10 weight percent of the total weight.

### Preparation of the Battery Anode

A commercially available graphite anode material can be used. It can be electrochemically lithiated prior to assembly of the battery. For example, full size electrodes (44 cm²) can be layered with Celgard 2400 separator and lithium metal foil for lithium intercalation. A constant current can be applied and voltage can be monitored to a cut off of 0.01 V vs. lithium to avoid damaging the graphite structure by over lithiation. The anodes can have a capacity in excess of 320 mAh/g.

### Battery Design

A design model that works well with typical prismatic cell designs can be developed. A battery design spreadsheet can be used to evaluate the effect of material and electrode design changes on battery performance characteristics and can be implemented in this invention. The spreadsheet can be designed to calculate performance characteristics of prismatic lithium cells with a stacked electrode configuration. The spreadsheet can allow the user to input a variety of battery, material and electrode design properties.

The following examples illustrate further the invention but, of course, should not be construed in any way of limiting its scope.

Preparation of Hydrogel and Xerogel

A 3 liter round bottom flask can be charged with 1 liter of water. Dissolved oxygen can be purged from the water in the flask by bubbling argon. After purging, the monomer for the desired conducting polymer can be introduced as a solution by syringe through a rubber septum. 100 g of triisopropoxy vanadium oxide (TIVO) can be added dropwise by syringe through the rubber septum over the course of 1 hour while the solution can be vigorously stirred. The resulting solution can be allowed to rest for 24 hours in which time gelation of V₂O₅ occurred. Excess water can be removed by rotary evaporation to yield a viscous gel. The hydrogel can be allowed to further dry on the bench top for 24 hours before final drying at 110° C. to arrive at the xerogel.

X-Ray Diffraction of Composite Material

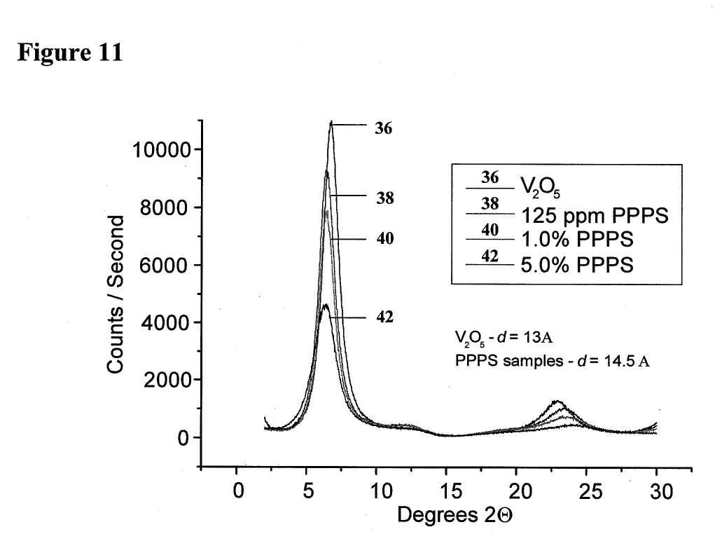

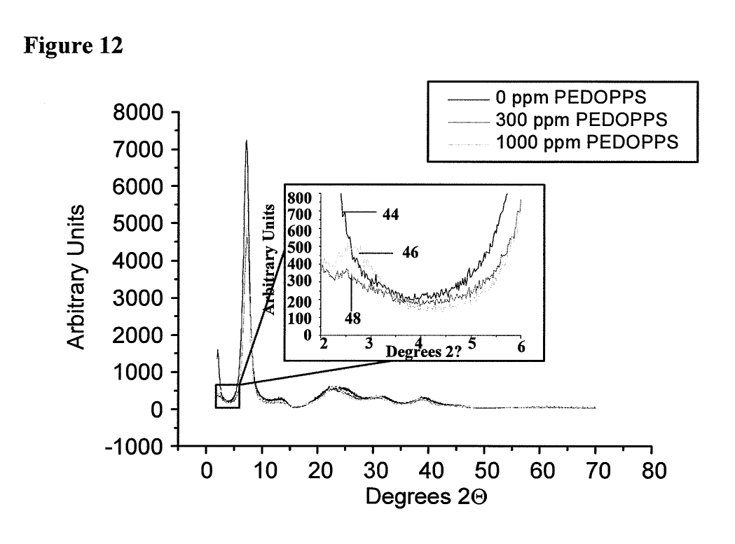

Samples for X-Ray diffraction (XRD) were prepared by drop wise addition of the PPPS or PEDOPPS V₂O₅ sol-gel composites to glass slides. The deposit areas were on the order of 3 cm². All samples were dried on the bench top for 8 hours prior to drying under vacuum at 110° C. for 24 hours. XRD data was gathered on a Scintag X-2000 powder diffractometer at a rate of 2° Θ/min. between 2 and 70 2Θ with Cu Kα radiation. The results are depicted in FIGS. 11 and 12.

Trace 36 in FIG. 11 shows the XRD data for V₂O₅. Traces 38, 40 and 42 show the corresponding XRD data of V₂O₅/PPPS composites with varying amounts of PPPS. The d-spacings for layer to layer distances in V₂O₅ xerogels can be a function of the water content of the material. The range is reported to be from 13 to 8.5 Å for water contents from 3 to 0.8 molecules of water for each V₂O₅ unit. Trace 36 in FIG. 11 for an unmodified V₂O₅ sample shows a reflection in the 001 plane at 6.8° 2Θ corresponding to a layer spacing of 13 Å. Traces 40 and 42 can be for PPPS modified samples and all show a 001 reflection 6.2° 2Θ corresponding to a layer spacing of 14.3 Å. The wider layer separation can be due to inclusion of PPPS chains between the vanadium layers. The trend with increasing PPPS concentration is a broadening of the 001 peak characteristic of a decrease in domain size. This trend indicates, that as the polymer is added to the system, the short range order of the xerogel matrix decreases, forcing the V₂O₅ bi-layer ribbons to adopt a more amorphous morphology.

Trace 44 in FIG. 12 at approximately 8° 2Θ shows a reflection in the 001 plane and corresponds to a layer spacing of 11.5 Å. Traces 46 and 48 in FIG. 12 show a growth of a peak at 2.5 2Θ corresponding to a layer spacing of 35 Å with increasing concentration of PEDOPPS.

Electron Diffraction of Composite Material

In addition to the structural information obtained by the XRD experiments, electron diffraction was used to further clarify the molecular level changes brought on by polymer inclusion in the V₂O₅ matrix. Samples were prepared by dipping gold coated transmission electron microscopy grids into V₂O₅ and 300 ppm V₂O₅/PPPS hydrogels. The coated grids were dried on the bench top for 24 hours before additional drying at 10° C. under vacuum. One of two V₂O₅/PPPS coated grids was used as the working electrode in a typical 3 electrode cell and underwent a two electron reduction simulating discharge.

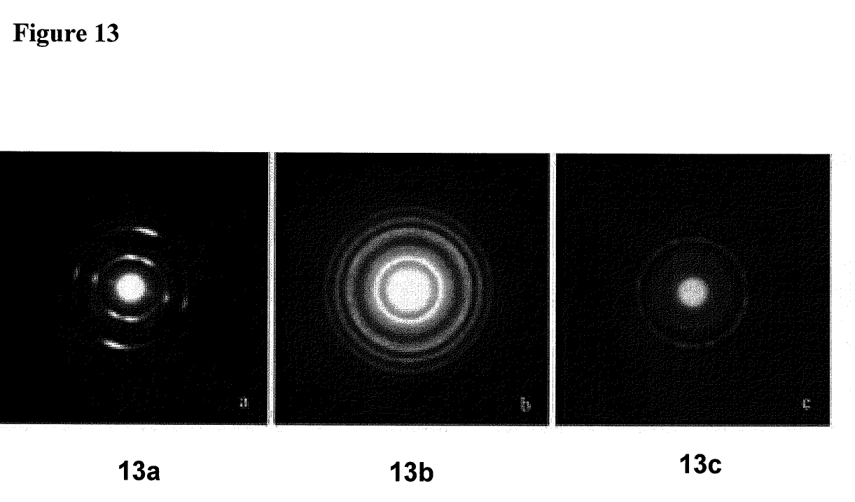

FIGS. 13a-13c show the electron diffraction patterns for V₂O₅ and the 300 ppm V₂O₅/PPPS composite in the oxidized and reduced states. The parent material (FIG. 13a) shows well defined spots that are characteristic of a crystalline material. Indexing of this diffraction pattern agrees well with values known in the art. FIG. 13b shows the diffraction pattern for V₂O₅ composite including 300 ppm PPPS. The diffraction pattern is less defined and is characteristic of a material that has a very small crystallite size. Indexing of this pattern shows that the atomic arrangements have not been altered. There has been a reduction in the domain size.

FIG. 13c is the diffraction pattern of a V₂O₅ composite including 300 ppm PPPS after a two electron reduction. Several of the rings present in the prepared material (FIG. 13b) are absent in FIG. 13c suggesting that lithium intercalation causes a random rearrangement of the structure. The rings that do remain match indexing associated with both the parent and PPPS modified samples. These data suggest there are measurable changes occurring in the structure of V₂O₅ both with polymer inclusion and lithium intercalation.

The electrochemical enhancement of V₂O₅ due to PPPS inclusion can be because the polymer chains form a template that controls and directs the growth of V₂O₅. The templating can occur in the vicinity of the highly dispersed polymer chains and the pattern (or lack thereof) is then repeated through the growing V₂O₅ matrix. In effect, the polymer is directing the disorder in structure of the V₂O₅ on the bi-layer molecular level as is indicated by the electron diffraction results.

V₂O₅/Conducting Polymer Composite Micron Particulate Formation

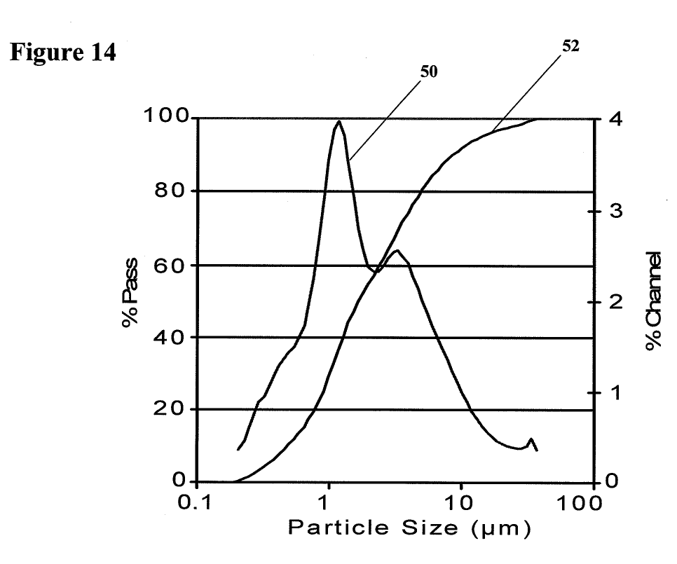

V₂O₅/PPPS composite was milled to reduce particle size. FIG. 14 shows the particle size distribution for milled composite cathode material. d₁₀=0.47 μm, d₅₀=1.6 μm, d₉₀=8 μm. Trace 50 in FIG. 14 corresponds to the “probability density function” and trace 52 corresponds to the “cumulative distribution function.” The particle size analysis shown in FIG. 14 indicates a bimodal distribution with 90% of the particles under 8 μm.

### Test Results

The cathode formulation was paired with both lithium metal and graphite anodes in several different cell configurations to ascertain the performance characteristics. In all cases the electrolyte used was 1.0 M LiPF₆ in a 1:1 mixture of ethylene carbonate (EC) and dimethyl carbonate (DMC). The separator material used was Celgard 2800, a 21 μm thick polyethylene membrane with 43% porosity that is typically used in lithium-ion battery applications. Charge/discharge conditions were controlled with Maccor battery testers.

V₂O₂ Composite Cathode Vs. Lithium Anode

Initial testing on the cathode was performed using a lithium metal anode to eliminate complications to the electrochemistry brought on by contributions from a graphite intercalation anode. The lithium used was 99.99% pure foil that was roll milled to a thickness of ˜100 μm prior to cleaning in an inert atmosphere with hexanes and acetone. Appropriate sizes based on the test vehicle being used were cut from the foil stock with punches.

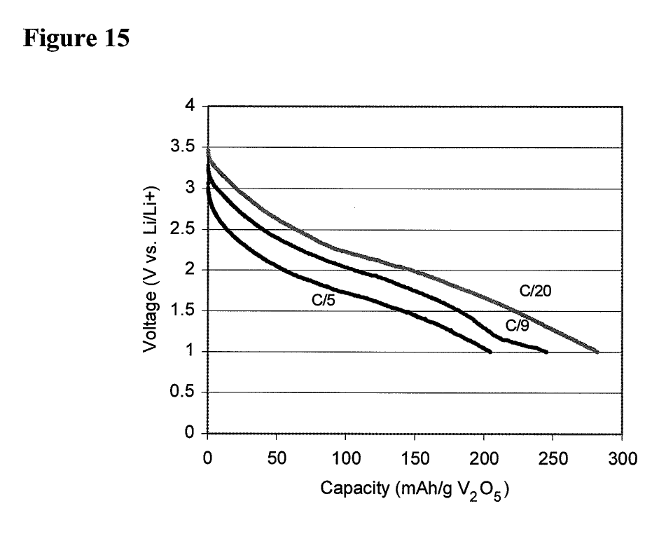

Discharge curves at the third cycle for three puck cells including V₂O₅ composite cathode and lithium metal anode at three discharge rates appear in FIG. 15. The capacity is reported as a function of the mass of the V₂O₅ active material. The samples show a rate dependant capacity response. Over the discharge rate range of C/20 to C/5 the measured capacity decreases from 275 mAh/g to 210 mAh/g. These data clearly indicate that, at moderate rates, the V₂O₅ composite shows very attractive capacity.

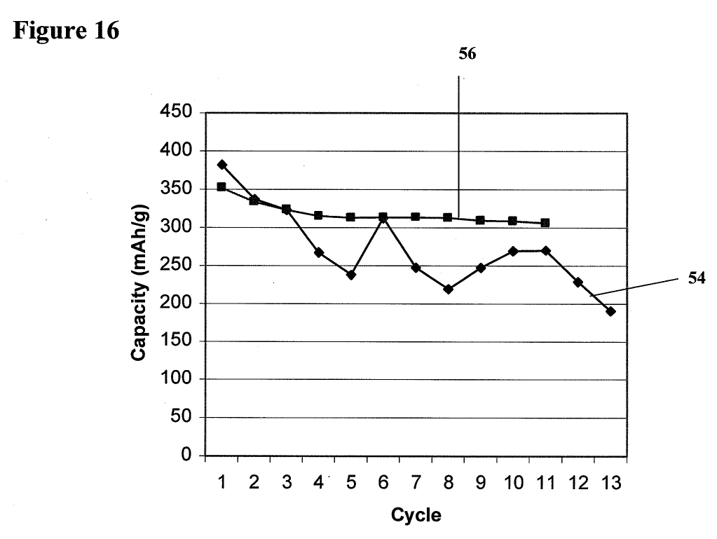

FIG. 16 shows the discharge capacities for two 2016 coin cells including V₂O₅ composite cathode and lithium metal anode. The data points of trace 54 show fluctuations in capacity over 13 cycles with eventual deterioration due to lithium dendrite formation. On the other hand, the data points of trace 54 show excellent capacity, greater than 300 mAh/g, for the first eleven cycles. This suggests that the composite V₂O₅ cathode material, when formulated and deposited as a typical industrially acceptable material, has the potential to drastically improve rechargeable lithium ion battery performance.

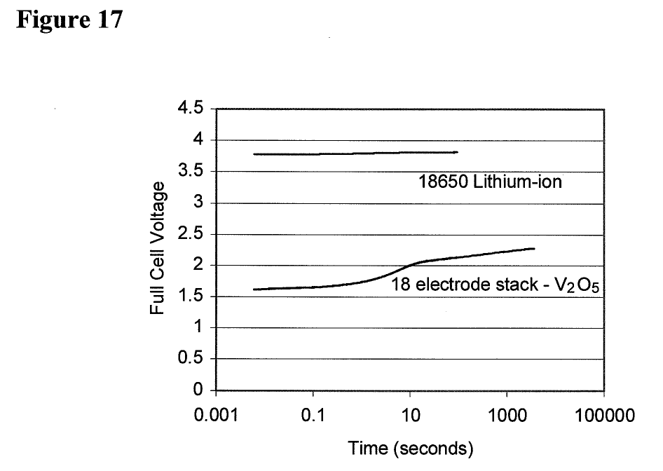

FIG. 17 compares the polarization of a typical LiCoO₂ based 18650 cell with one of the large format V₂O₅/PPPS cells. In this experiment a similar discharge current was applied to both of the cells and was then interrupted. The measured change in voltage upon switching from the load to no-load condition is a combination of the electrical and chemical polarization of the particular system and can be referred to as the recovery voltage. Examination of the plot shows that the polarization for the V₂O₅/PPPS cell is ˜0.4 volts while the same for the 18650 cell is approximately 0.10 V. This suggests that the V₂O₅/PPPS material is inherently more resistive than LiCoO₂.

Variations, modifications, and other implementations of what is described herein will occur to those of ordinary skill in the art without departing from the spirit and the scope of the invention. Accordingly, the invention is not to be limited only to the preceding illustrative descriptions.

What is claimed is:

1. A battery cathode comprising:
carbon particulates;
micron-sized particles of vanadium pentoxide modified with poly(pyrrole propanesulphonate); and
a polymer binder, the carbon particulates and the micron-sized particles of vanadium pentoxide modified with poly(pyrrole propanesulphonate) being disposed within the polymer binder.

2. The battery cathode of claim 1, wherein the micron-sized particles of vanadium pentoxide modified with poly(pyrrole propanesulphonate) include at most 400 ppm of poly(pyrrole propanesulphonate).

3. The battery cathode of claim 1, wherein the micron-sized particles of vanadium pentoxide modified with poly(pyrrole propanesulphonate) include between 150 ppm and 300 ppm poly(pyrrole propanesulphonate).

4. The battery cathode of claim 1, wherein the micron-sized particles of vanadium pentoxide modified with poly(pyrrole propanesulphonate) comprise between about 75 weight percent and about 90 weight percent of the total weight.

5. The battery cathode of claim 1, wherein the carbon particulates comprise between about 7 weight percent and about 15 weight percent of the total weight.

6. The battery cathode of claim 1, wherein the polymer binder comprises between about 3 weight percent and 10 weight percent of the total weight.

7. The battery cathode of claim 1, wherein the carbon particulates are selected from the group consisting of acetylene black particles, graphite flakes, and combinations thereof.

8. The battery cathode of claim 1, wherein the polymer binder is polyvinylidene fluoride.

9. A battery cathode comprising:
carbon particulates;
micron-sized particles of vanadium pentoxide modified with a conducting polymer to form a bi-layer ribbon structure having a bi-layer spacing of about 13.5 to about 15 Angstroms; and
a polymer binder, the carbon particulates and the micron-sized particles of vanadium pentoxide modified with the conducting polymer being disposed within the polymer binder.

10. A method of making a cathode composite, the method comprising:
forming a xerogel of poly(pyrrole propanesulphonate) modified vanadium pentoxide;
processing the xerogel to form micron-sized particles of poly(pyrrole propanesulphonate) modified vanadium pentoxide;
mixing the micron-sized particles of poly(pyrrole propanesulphonate) modified vanadium pentoxide with carbon particulates and a polymer binder to form the cathode composite.

11. The method of claim 10, wherein forming a xerogel of poly(pyrrole propanesulphonate) modified vanadium pentoxide comprises:
mixing poly(pyrrole propanesulphonate) in monomer form and water to form a water solution;
adding vanadium(V)oxytrialkoxides to the water solution to form a hydrogel of poly(pyrrole propanesulphonate) modified vanadium pentoxide; and
removing excess water to form the xerogel.

12. The method of claim 11, wherein the hydrogel has a bi-layer ribbon structure with a bi-layer spacing of about 9 Angstroms to about 13 Angstroms.

13. The method of claim 11, wherein at least a portion of the poly(pyrrole propanesulphonate) is formed in the bi-layer ribbon structure of the hydrogel.

14. The method of claim 11, wherein the vanadium(V)oxytrialkoxides includes triisopropoxy vanadium oxide.

15. The method of claim 10, wherein the xerogel contains at most 400 ppm of poly(pyrrole propanesulphonate).

16. The method of claim 10, wherein processing the xerogel comprises milling the xerogel.

17. The method of claim 13, wherein milling is used to produce particles having an average size of about 5 to about 10 microns.

18. The method of claim 10 further comprising:
applying an adhesion layer to an aluminum foil current collector;
depositing a slurry on the adhesion layer, the slurry including (i) the carbon particulates; (ii) the micron-sized particles of poly(pyrrole propanesulphonate) modified vanadium pentoxide; and (iii) the polymer binder; and
drying the slurry to form a battery cathode.

19. A battery comprising:
a cathode including a layer formed from a composite material including (i) particulates of carbon, (ii) micron-sized particles of vanadium pentoxide modified with poly(pyrrole propanesulphonate), and (iii) a polymer binder
an anode including lithium ions; and
a porous separator and an electrolytic solution disposed between the cathode and the anode.

20. The battery of claim 19, wherein the micron-sized particles of vanadium pentoxide modified with poly(pyrrole propanesulphonate) have an average size of about 5 to 10 microns.

21. The battery of claim 19, wherein the micron-sized particles of vanadium pentoxide modified with poly(pyrrole propanesulphonate) contain at most 400 ppm of poly(pyrrole propanesulphonate).

22. The battery of claim 19, wherein the micron-sized particles of vanadium pentoxide modified with poly(pyrrole propanesulphonate) comprise between about 75 weight percent and about 90 weight percent of the composite material.

23. The battery of claim 22, wherein the carbon particulates comprise between about 7 weight percent and about 15 weight percent of the composite material and the polymer binder comprises between about 3 weight percent and 10 weight percent of the composite material.

24. A method of making composite particulates, the method comprising:
forming a xerogel of poly(pyrrole propanesulphonate) modified vanadium pentoxide; and
milling the xerogel to form micron-sized particulates of poly(pyrrole propanesulphonate) modified vanadium pentoxide.

25. The method of claim 24, wherein forming a xerogel of poly(pyrrole propanesulphonate) modified vanadium pentoxide comprises:
mixing poly(pyrrole propanesulphonate) in monomer form and water to form a water solution;
adding vanadium(V)oxytrialkoxides to the water solution to form a hydrogel of poly(pyrrole propanesulphonate) modified vanadium pentoxide; and
removing excess water to form the xerogel.

26. The method of claim 25, wherein the hydrogel has a bi-layer ribbon structure with a bi-layer spacing of about 9 Angstroms to about 13 Angstroms.

27. The method of claim 25, wherein at least a portion of the poly(pyrrole propanesulphonate) is formed in the bi-layer ribbon structure of the hydrogel.

28. The method of claim 25, wherein the vanadium(V)oxytrialkoxides includes triisopropoxy vanadium oxide.

29. The method of claim 24, wherein milling the xerogel comprises milling the xerogel with an attritor mill to produce particulates having an average size of about 5 to about 10 microns.
